(19) United States
(12) Patent Application Publication
(10) Pub. No.: US 2006/0218890 A1
(43) Pub. Date: Oct. 5, 2006

(54) Method and apparatus for grooming a grass lawn

(76) Inventor: Dennis Lee Welch, Ord, NE (US)

Correspondence Address: Philip J. Lee;Suite 525, 10050 Regency Circle, Omaha, NE, 68114, US

(21) Appl. No.: 11/092,322

(22) Filed: Mar. 29, 2005

(51) Int. Cl. A01D 34/03

(52) U.S. Cl. 56/400.04

(57) ABSTRACT

A method and apparatus for grooming a grass lawn surface includes attaching a raking device having a lateral array of tines to the rear of a conventional lawnmower and operating the mower over the lawn surface while the tines of the raking device are allowed to contact the lawn, the contact of the tines with the lawn and the attachment of the raking device to the mower providing the support for the raking device, the apparatus including the assembled mower and raking device.

### BACKGROUND OF THE INVENTION

A. Field of Invention

The present invention relates generally to methods and apparatus for mowing grass lawns and more particularly to a new and improved method of cutting and grooming cut grass by means of an apparatus comprised of a novel assembly of a rake device attached to a conventional lawnmower.

B. Description of Related Art

Conventional methods of mowing grass lawns include operation of conventional lawnmowers over the grass lawn with the grass being cut by the mower and the clippings are either recut and distributed back into the lawn in a mulching action, collected in a bag, or simply left on the lawn. Such methods leave parts of the grass packed down by the mower wheels causing unsightly marks on the otherwise smooth lawn, and frequently leave clumps of cut grass that are also unsightly and may cause the underlying lawn to die. Conventional rotary powered lawn mowing devices may use a flap at the rear of the mower deck to provide some protection against objects being hurled at the operator, and two wheeled, reel type mowing devices may use a roller to balance the mower. Neither of such mechanisms groom the cut grass or eliminate the mower wheel tracks. Using a mulching mower requires very frequent mowing to try to avoid clumping, but when the grass has grown sufficiently, the use of a mulching mower can be expected to leave clumps of cut grass. The conventional method of achieving a well groomed lawn comprises the difficult and inconvenient task of raking the lawn by hand after mowing and collecting the cut grass. This task is so labor intensive that it is not performed in ordinary circumstances and the usual practice is that the clumps and wheel tracks are just tolerated despite the unsightly appearance and damage to the lawn. In the case of a large lawn requiring a riding type mower, such mowers or small tractors may have drawbar or other towing attachments that could accommodate a self supporting, wheeled raking device such as that shown in U.S. Pat. No. 4,406,113 to Mullins. For the usual residential grass lawn; however, the tractor type riding mower is not appropriate and the usual mower is of the type having a rearward projecting handle by which the mower is either pushed or guided while the operator walks behind the mower. A wheeled raking device such as shown in the Mullins parent would extend into the path of the operator of a walk behind type mower and interfere with the feet of the operator, as well as prevent the use of a rear mounted grass collection bag.

It would therefore be desirable to provide a method of mowing grass lawns that conveniently grooms the freshly cut lawn to break up clumps of cut grass and eliminate wheel tracks without requiring a riding mower, and for an attachment to a conventional walk behind lawnmower that conveniently and economically carries out the grooming process.

### SUMMARY OF THE INVENTION

The method of the present invention comprises assembling a raking device to the rear of a conventional lawn mower, the raking device having sufficient width to effectively eliminate the wheel tracks. In accordance with the illustrated embodiment of the present invention, a frame assembly is fixedly attached to the to the rear of a lawnmower. The frame assembly supports a hinged rake assembly that may be raised or lowered onto the lawn surface, as desired by the user. The rake assembly is lightweight and need not be supported by wheels, but can be raised for ease in maneuvering. The tines of the rake assembly include a grass engaging portion that is configured to are contact the lawn between the mowing device and the operator at an acute angle to the lawn on the side toward the mowing device and at an obtuse angle toward the operator. The angled contact of the rake tines with the lawn surface allows the rake device to be easily dragged behind the mower without collecting grass clippings. The weight of the rake device is sufficient to cause the rake tines to brush the lawn surface, lightly combing the blades of grass and thereby erasing any wheel tracks and dispersing any clumps of cut grass clippings.

The principle aim of the present invention is to provide a new and improved method of mowing a grass lawn that meets the foregoing requirements and is convenient to perform.

Another and further object and aim of the present invention is to provide a new and improved device for carrying out the method according to the foregoing method and which is economically assembled.

Other objects and advantages of the invention will become apparent from the Description of the Preferred Embodiments and the Drawings and will be in part pointed out in more detail hereinafter.

The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is a pictorial diagram of the rake device of the present invention as it is typically mounted on and used with a conventional push-type lawnmower.

FIG. 2 is a rear pictorial view of the lawnmower and rake device in accord with the present invention

FIG. 3 is a detailed diagram illustrating a handle bracket within which a control rod of the rake attachment is retained and the position of the control rod within the handle bracket when the rake attachment is in a raised position.

FIG. 4 is a detailed diagram illustrating the handle bracket of FIG. 3 and the position of the control rod within the handle bracket when the rake attachment is in a lowered position.

### DESCRIPTION OF THE PREFERRED EMBODIMENT(S)

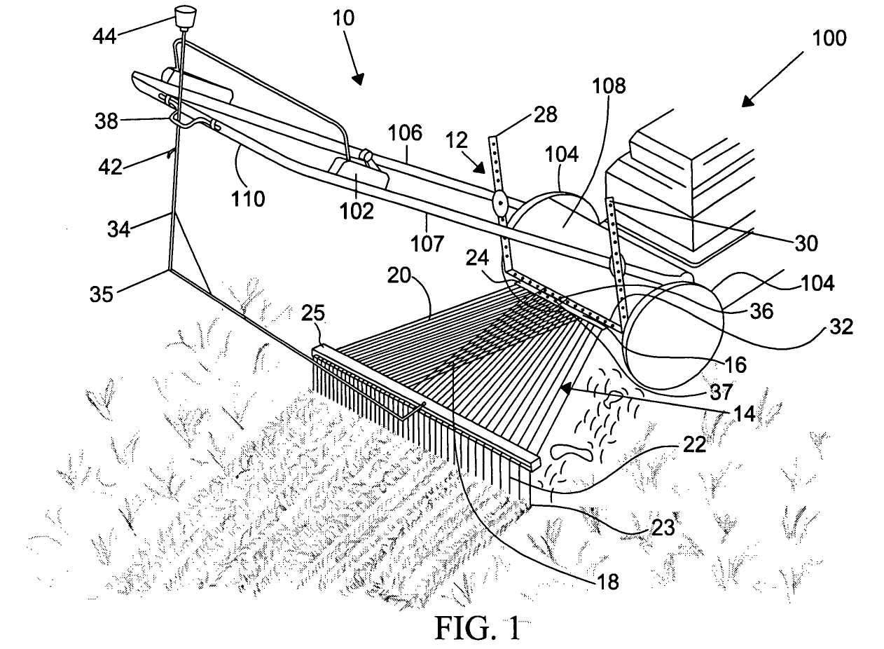

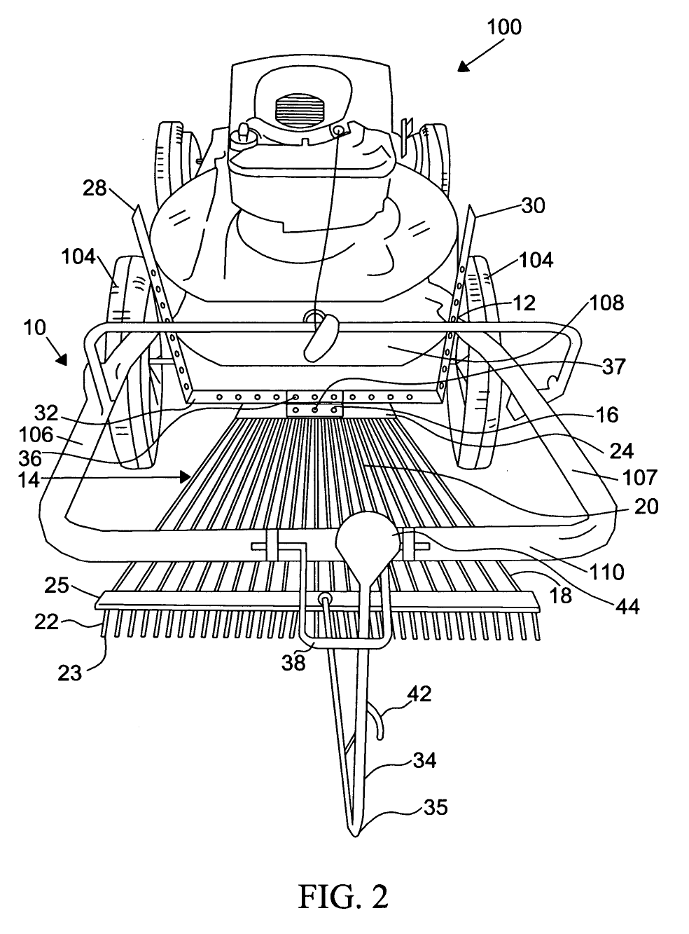

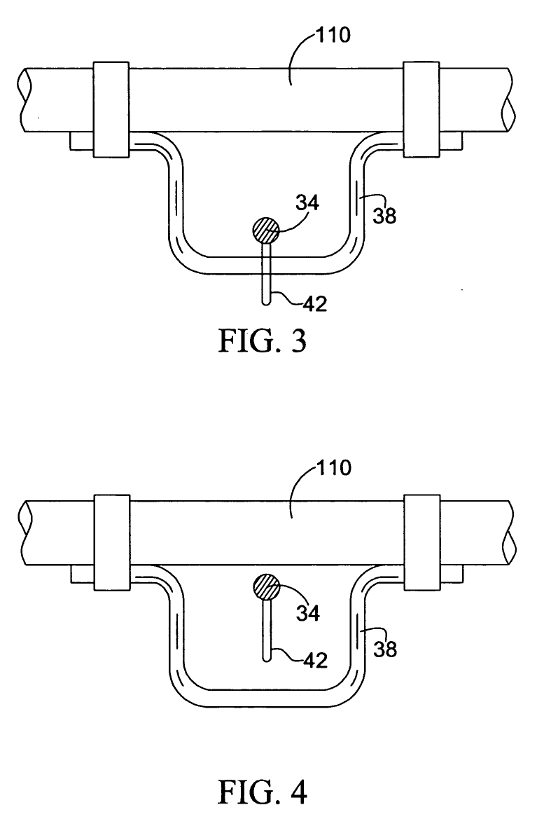

With reference to the Drawings wherein like numerals represent like parts throughout the Figures, a device constructed to carry out the with the method of the present invention is generally designated by numeral 10 in FIGS. 1 and 2. Device 10 comprises a frame assembly 12 and a raking device 14 attached thereto by a hinge 16. The method of the present invention comprises automatically raking the cut lawn surface immediately after the mower passes over it by attaching a raking device 14 to or adjacent to the rear deck 108 of a conventional mower 100, having a rearward extending handle 102 with which the operator can push or guide the mower 100 while walking behind the mower. A simple frame 12 is bolted to the mower handle 102 and the raking device 14 is hingedly attached to the frame 12 and is thus supported by the mower 100 and by the contact of the raking device 14 with the lawn. The raking device 14 can be elevated above the lawn surface, in which case the mower 100 is the sole support of the raking device 14. A lifting mechanism is preferably installed to allow the raking device 14 to be lifted above and off the lawn surface and releasably held in an elevated position supported by the mower handle 102. Mowing a grass lawn according to the method of the present invention after assembly and attachment of the raking device 14 to the mower 100 comprises operating the mower 100 as one would ordinarily do, allowing the raking device 14 to rake the cut section of grass behind the mower 100, and elevating the raking device 14 as may be convenient for backing or otherwise maneuvering the mower 100.

Raking device 14 as shown in the drawings is constructed to carry out the method of the present invention and comprises a lateral array of tines 18, each tine 18 comprising a flat section 20 and an angled section 22, angled sections 22 being formed at an obtuse angle relative to tine flat sections 20. Tines 18 are formed of a flexible resilient material such as thin steel or plastic, capable of temporarily deforming and returning to its original shape. Tines 18 are clamped together in a lateral array by a front clamp member 24 and a rear clamp member 25, such that the tine flat sections 20 are aligned in a planar fashion. The ends of angled tine sections 22 comprise tips 23, which are aligned to form a linear contact with the lawn when the raking device 14 is in a lowered position. The linear contact of the tine tips 23 may be laterally straight across or may be a laterally extending arc, so long as the tips 23 are flat in the plane of the lawn. The angled tine sections 22 are angled downward and rearward to contact the lawn at an angle less than 90 degrees, sufficient to allow tine tips 23 to brush over the lawn and disperse rather than accumulate or collect clippings of cut grass. Raking device 14 is secured to rake frame 12 by attaching a hinge 16 between and to the frame 12 and the raking device 14, such that the axis of the hinge 16 is lateral with respect to the mower 100 and raking device 14 is able to swing up or down through its vertical angle relative to the mower 100. It is anticipated that the mower handle 102 will comprise two angled members 106 and 107 attached to the mower proximate to each side of the rear mower deck 108, and a horizontal member 110 connecting the upper ends of angled handle members 106 and 107 at a position to be conveniently gripped by the mower operator. Frame 12 comprises vertical support members 28 and 30 that are bolted to the angled mower handle members 106 and 107, respectively, at a convenient location above the rear deck 108 of the mower, and a horizontal frame member 32 attached at either end to vertical support members 28 and 30. It will be anticipated that mowers are of differing dimensions and configurations, but universally comprise a deck and handle and therefore, vertical frame members 28 and 30, as well as horizontal frame member 32 are drilled or otherwise adapted to be adjustable in the positions of attachment to a mower such that as a result of the adjustable attachment, horizontal frame member 32 is secured in a horizontal position relative to the mower and at a right angle to the front to back center line of the mower 100. The attachment of horizontal frame member 32 to vertical frame members 28 and 30 is similarly adjustable such that the height of horizontal frame member 32 relative to the lawn surface is adjustable and level. Hinge 16 is secured to the center of horizontal frame member 32 by a series of bolts 36 and to front clamp member 24 by a series of bolts 37, and it will be anticipated that alternative means for attaching the hinge 16 between frame 12 and raking device 14 are available and may be used without departing from the spirit of the present invention.

Front and rear clamp members 24 and 25 serve to maintain lateral separation between the individual tines 18. Raking device 14 is generally fan shaped with the lateral separation of tines 18 being greater at rear clamp member 25 than at front clamp member 24, such that the contact of tine tips 23 with the lawn is wider than the wheels 104 of the mower and the front clamp member 24 is narrow enough to fit easily between the rear wheels 104 and the sides of the mower handle. The rake device 14 is thereby be wide enough so that the overall width of the array of tine tips 23 is sufficient to cover any wheel marks in the lawn made by the lawnmower 100. Tines 18 are short enough that the rearward extension of raking device 14 is less that the rearward extension of he mower handle 102 to avoid interference with the operator walking behind mower 100 while gripping mower handle 102. A control rod 34 is attached to rear clamp member 25 and extends rearward and relatively horizontally to a bend 35 from which it extends relatively vertically and upwardly to and through a U shaped handle bracket 38 that is attached to horizontal handle member 110. A hook shaped stop 42 is fixedly attached along control rod 34 below a control rod handle 44 affixed to the end of control rod 34 above bracket 38. Stop 42 can be releasably engaged by handle bracket 38, as illustrated in FIG. 4, when the operator pulls control rod handle 44 upward to lift stop 42 through bracket 38, whereby control bar 34 is moved upwardly lifting the rear of raking device 14 such that tine tips 23 do not contact the lawn. Handle 44, mounted at the upper end of control rod 34, permits the user to easily raise and lower control rod 34, engaging and disengaging stop 42 in bracket 38 as needed.

The method of the present invention comprises attaching raking device 14 to a lawn mower 100 and operating the mower 100 with raking device 14 in its lowered position such that the tine tips 23 are in contact with the lawn surface. When desired, the user may lift control rod 34 to move raking device 14 to its raised position, whereby tine tips 23 are not in contact with the lawn. Raking device 14 may be held in the raised position by engagement of stop 42 within handle bracket 38. The attachment and use of the raking device 14 will not prevent use of lawn clipping collection bags, which may be desired as the angle of tines 18 of raking device 14 is designed to avoid collecting grass clippings.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A method of grooming a grass lawn comprising assembling a raking device by assembling multiple tines in a lateral array with a first, forward end narrower than the width of the mower wheels and a second, rearward end wider than the width of the mower wheels, attaching the raking device to the rear of a conventional lawn mower having at least two laterally positioned wheels and a rearward and upward extending handle, operable by an operator positioned behind the mower, by constructing a frame having two vertical members and a horizontal member adjustable attached between the vertical members, adjustable attaching the vertical frame members to the mower, and attaching a hinge between the raking device and the horizontal frame member, allowing the raking device to engage the lawn surface between the operator and the mower, and operating the mower over the lawn surface.

2. (canceled)

3. (canceled)

4. The method of claim 1, wherein the step of assembling the raking device further comprises forming and assembling the tines to angle downward and rearward at the second, rearward end.

5. The method of claim 4, wherein the raking device is attached to the mower by attaching the vertical frame members to the mower handle such that the horizontal frame member is positioned proximate to the rear of the mower.

6. The method of claim 5, wherein the step of attaching the raking device to the mower further comprises the step of attaching a lifting rod to the raking device and mounting means for releasably engaging the lifting rod on the mower handle.

7. The method of claim 6, wherein the step of attaching the raking device to the mower further comprises positioning the raking device with the second, rearward end closer to the rear of the mower than the operator.

8. The method of claim 7, wherein the step of operating the mower further comprises raising the raking device by upward operation of the lifting rod when necessary or convenient for backing or avoiding obstacles.

9. An apparatus for grooming a grass lawn comprising a raking device attached to a conventional lawn mower having at least two laterally positioned wheels and a rearward and upward extending handle, operable by an operator positioned behind the mower, the raking device comprising multiple tines assembled in a lateral array with a first front end narrower than the distance between the inside of the mower wheels and a second, rearward end wider than the distance between the outside of the mower wheels, the tine array attached to the mower by means of a frame having two vertical members adjustably attached to the mower handle and a horizontal member adjustable attached between the vertical members, and a hinge attached between the horizontal frame member and the first, front end of the tine array, the axis of the hinge being horizontal and perpendicular to the front to back axis of the mower, whereby the second, rearward end of the tine array is allowed to rotate vertically to contact or disengage from the lawn to be groomed.

10. (canceled)

11. (canceled)

12. The apparatus of claim 9, wherein the tines are bent and assembled to angle downward and rearward at the second, rearward end of the tine array.

13. The apparatus of claim 12, wherein the raking device is attached to the mower such that the horizontal frame member is positioned proximate to the rear of the mower.

14. The apparatus of claim 13, further comprising a lifting rod attached to the second end of the tine array and means for releasably engaging the lifting rod mounted on the mower handle.

15. The apparatus of claim 14, wherein the second, rearward end of the tine array is positioned closer to the rear of the mower than the operator.

16. The apparatus of claim 15, wherein the first, front end of the tine array is supported by the frame and the second, rearward end of the tine array is supported by the contact of the tines with the lawn to be groomed when the lifting rod is not engaged and by the lifting rod when the lifting rod is engaged.
